(19) United States
(12) Patent Application Publication
(10) Pub. No.: US 2026/0270340 A1
(43) Pub. Date: Sep. 10, 2026

(54) SYSTEMS AND METHODS FOR MOBILE EMERGENCY RESPONSE APPLICATIONS FOR WIRELESS DEVICES

(71) Applicant: CENTRALSQUARE TECHNOLOGIES, LLC, Lake Mary, FL (US)

(72) Inventors: James Patrick Jones, JR., Huntley, IL (US); Andrea Weeg, Berlin, MD (US); Christopher Paul Arries, Palm Harbor, FL (US)

(73) Assignee: CENTRALSQUARE TECHNOLOGIES, LLC, Lake Mary, FL (US)

(21) Appl. No.: 19/561,202

(22) Filed: Mar. 9, 2026

Related U.S. Application Data
(60) Provisional application No. 63/769,676, filed on Mar. 10, 2025.

(51) Int. Cl. H04M 1/72421; H04M 1/72424

(52) U.S. Cl. CPC H04M 1/72421; H04M 1/72424; H04M 2201/42

(57) ABSTRACT

The present disclosure discloses mobile emergency response systems and methods for accessing, transferring, processing, and displaying emergency event information using a mobile device. In some embodiments, the system includes at least one processor and at least one mobile device executing a mobile emergency response application. The processor may remotely access emergency event information from multiple data sources, transfer the emergency event information to the mobile device, process and configure the emergency event information, and display the emergency event information via a graphical user interface on the mobile device. Processing may include normalizing information from different source formats, preparing multimedia for preview, and updating user interface state. The graphical user interface may provide text/icons, media previews, user-interactive windows, and user-selectable filters. The emergency event information may be refreshed based on user inputs and/or updates to the data sources, and access may include password verification.

### CROSS REFERENCE TO RELATED APPLICATIONS

This application claims the benefit of priority of U.S. Provisional Application No. 63/769,676, filed on March 10, 2025, which is incorporated herein by reference in its entirety.

### TECHNICAL FIELD

The present disclosure relates generally to computer-implemented systems and methods for managing and presenting emergency incident information using mobile computing devices. More specifically, and without limitation, this disclosure relates to software applications and related computing architectures for accessing, processing, and displaying emergency response information obtained from one or more data sources, including Computer Aided Dispatch (CAD) systems, Geographic Information Systems (GIS), and related emergency response data platforms.

### BACKGROUND

Emergency response operations often depend on timely access to accurate and current information regarding an emergency event. In many situations, details associated with an incident can evolve rapidly, and reliance on incomplete or outdated information may adversely affect decision-making and coordination among responding personnel. Such circumstances can contribute to delayed response, extended wait times, inefficient allocation of resources (including overstaffing or understaffing), and inappropriate preparation or treatment decisions when information available to responders no longer reflects conditions at the scene.

During emergency event response, responders frequently rely on laptops, tablets, mobile devices, or other computing devices that are physically connected to, mounted within, or otherwise associated with an emergency response vehicle to access incident-related information. However, these vehicle-associated devices may be difficult or impractical to use once responders leave the vehicle and move into the field. Carrying certain computing equipment to the scene may be cumbersome or unsuitable for the conditions, and device functionality may be constrained by connectivity limitations, including limited or unavailable network access at or near the incident location. These practical constraints can further inhibit access to contemporaneous information while responders are actively engaged on scene.

Additionally, emergency event information may be distributed across multiple systems and sources and may change over time as new information becomes available. In many deployments, this information may include location data, incident descriptors, contact information, and multimedia content, among other categories of data. As a result, responders and supporting personnel may face challenges in obtaining and using current incident information in a manner that supports effective on-scene decision-making and coordination. Accordingly, there remains a need for improved approaches for enabling access to up-to-date emergency event information during emergency response activities, including when responders are away from vehicle-associated computing resources.

### SUMMARY

In view of the foregoing, embodiments of the present disclosure provide computer-implemented systems, methods, and computer-readable media for managing emergency event information using one or more mobile computing devices. In some embodiments, the disclosed techniques relate to accessing emergency event information from a plurality of data sources, transferring such information for use on a mobile device, processing and configuring the information for presentation, and displaying the information on the mobile device. In some embodiments, the data sources may include one or more emergency-response-related platforms, including computer aided dispatch (CAD) systems, geographic information systems (GIS), and local mapping resources, among others.

One aspect of the present disclosure is directed to a mobile emergency response system. In some embodiments, the system includes a memory storing instructions, at least one processor configured to execute the instructions, and at least one mobile device configured to execute a mobile emergency response application. Execution of the instructions may cause the system to remotely access a plurality of data sources, transfer emergency event information from the plurality of data sources to the at least one mobile device, process and configure the emergency event information, and display the emergency event information on the at least one mobile device. In some embodiments, the system may update the emergency event information by refreshing the emergency event information at one or more times, wherein refreshing is based on at least one of user inputs made to the system or updates to the plurality of data sources.

In some embodiments, emergency event information may include one or more categories of information associated with a reported emergency event, including location information, an indication of a nature of emergency, contact information, and multimedia content such as video and photos. In some embodiments, the mobile emergency response application may be configured to display a graphical user interface (GUI) that presents the emergency event information using text and icons, provides user-interactive windows for accessing the emergency event information, and enables user editing and data updating. In some embodiments, processing and configuring the emergency event information includes normalizing emergency event information received from the plurality of data sources from one or more source formats into a normalized format usable by the mobile emergency response application for display. In some embodiments, access to emergency event information via the mobile emergency response application may require password verification, and the mobile emergency response application may provide a user interface including one or more filters selectable by a user to control which portions of the emergency event information are displayed on the at least one mobile device.

Another aspect of the present disclosure is directed to a method for real time emergency event information monitoring. In some embodiments, the method includes accessing, from a plurality of data sources, emergency event information corresponding to at least one reported emergency event; transferring the emergency event information from the plurality of data sources to at least one mobile device; processing and configuring the emergency event information; and displaying the emergency event information on the at least one mobile device. In some embodiments, the method further includes updating the emergency event information by refreshing the emergency event information at one or more times based on at least one of user inputs made via the mobile emergency response application or updates to the plurality of data sources. In some embodiments, displaying includes displaying the emergency event information via a GUI of the mobile emergency response application, and may include receiving a user selection of one or more filters and displaying portions of the emergency event information selected based on the one or more filters. In a further aspect, some embodiments are directed to a non-transitory computer-readable medium storing instructions that, when executed by at least one processor, cause performance of operations including remotely accessing the plurality of data sources, transferring emergency event information to at least one mobile device, processing and configuring the emergency event information, and displaying the emergency event information on the at least one mobile device.

It is to be understood that the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 illustrates an example emergency response scenario in which emergency responders desire access to up-to-date emergency event information after leaving an emergency response vehicle.

FIG. 2 illustrates an example arrangement in which emergency event information is made accessible to emergency responders outside of an emergency response vehicle via a remote data retrieval tool.

FIG. 3A illustrates an example system environment for a mobile emergency response application.

FIG. 3B is a block diagram illustrating example components of a mobile device server.

FIG. 4 illustrates an example flowchart of operations for obtaining emergency event information from one or more data sources and presenting the emergency event information on a mobile device.

FIG. 5 illustrates an example graphical user interface of a mobile emergency response application presented on a mobile device display.

### DETAILED DESCRIPTION

Reference will now be made in detail to exemplary embodiments, discussed with reference to the accompanying drawings. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be implemented and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed, without departing from the envisioned embodiments. Thus, the materials, methods, and examples are illustrative only and are not intended to be necessarily limited.

Emergency response scenarios can evolve rapidly as additional information becomes available, and responders may need to make time-sensitive decisions while operating under changing conditions at an incident scene. In many deployments, incident-related information may be recorded or updated in one or more systems that are accessible through equipment associated with an emergency response vehicle, while responders may spend significant time away from the vehicle when assessing conditions, coordinating resources, or providing care. These practical realities can make it difficult to maintain a current, shared view of incident information in the field. The embodiments described below relate to use of a mobile device application to facilitate access to emergency event information during emergency response activities, including when responders are away from vehicle-associated computing resources.

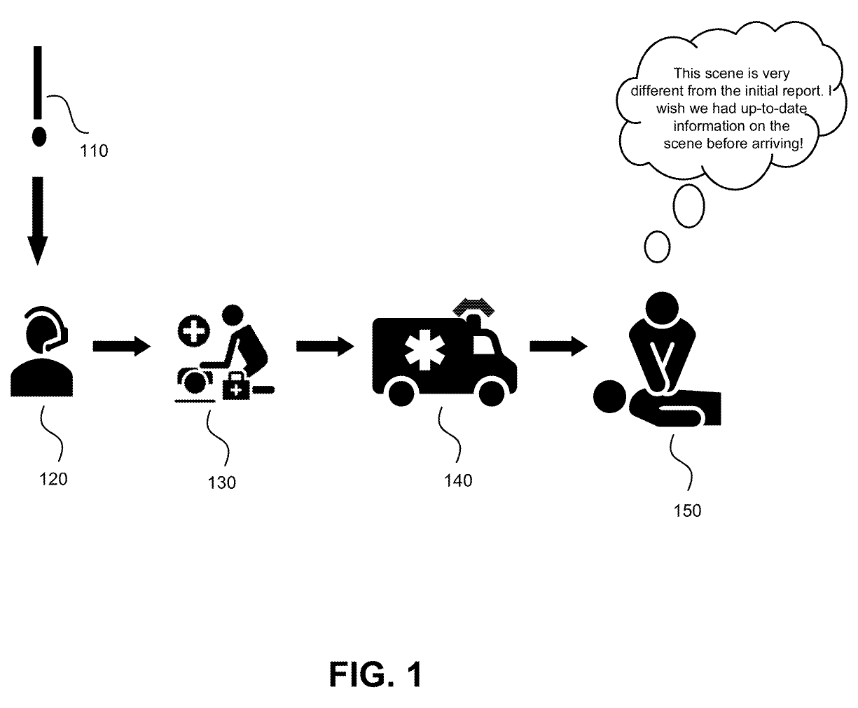

FIG. 1 illustrates an example operational context in which emergency dispatcher 120 may receive emergency event information 110 and may provide emergency event information 110 to emergency responders 130. In some embodiments, emergency responders 130 may begin responding to an emergency event 150 while traveling in an emergency response vehicle 140. Emergency event information 110 may be communicated to emergency responders 130 before arrival, and emergency event information 110 may also change after emergency responders 130 arrive and transition from operating in emergency response vehicle 140 to operating at or near emergency event 150. As illustrated, when emergency responders 130 are away from emergency response vehicle 140, emergency responders 130 may desire continued access to emergency event information 110 while responding to emergency event 150, including access to updated emergency event information 110 that may become available as conditions at emergency event 150 evolve.

Emergency event information 110 may include information associated with emergency event 150 that may be obtained, recorded, transmitted, updated, or otherwise made available during emergency response activities. In some embodiments, emergency event information 110 may include a caller location, which may be expressed as a street address, a nearby intersection, coordinates, a landmark reference, a building name, a floor indicator, a unit number, or other location descriptors. In some embodiments, emergency event information 110 may include a nature of emergency, which may include a medical incident, a fire-related incident, a law-enforcement-related incident, a traffic collision, a hazardous materials incident, a welfare check, an active threat report, or other incident classifications. In some embodiments, emergency event information 110 may include caller contact information, such as a callback number, a device identifier, a messaging identifier, or other contact information.

Emergency event information 110 may also include narrative and context information describing reported or observed conditions. For example, emergency event information 110 may include a brief description of what is occurring, the number of persons involved, whether injuries are reported, whether hazards are present, whether entry is obstructed, or whether special access instructions may be useful. In some embodiments, emergency event information 110 may include multimedia such as caller video or caller photos depicting emergency event 150, and emergency event information 110 may also include other digital content such as audio clips, attachments, or links. In some embodiments, emergency event information 110 may further include responder-entered notes, responder observations, status updates, timestamps, unit identifiers, staging instructions, and other information that may assist in coordination and response.

Emergency dispatcher 120 may include a person, entity, or system capable of receiving and responding to communications requesting emergency assistance. In some embodiments, emergency dispatcher 120 may receive emergency event information 110 via an emergency phone line, and emergency event information 110 may additionally or alternatively be received via text, a mobile application, a web form, a video call, an automated sensor feed, or another communication channel. Emergency dispatcher 120 may record emergency event information 110 in an emergency dispatch system, which may include one or more computing systems configured to store emergency event information 110 and to communicate emergency event information 110 to emergency responders 130. Emergency responders 130 may include, for example, law enforcement officers, firefighters, emergency medical services personnel, or other personnel assigned to respond to emergency event 150.

In some embodiments, once emergency dispatcher 120 receives emergency event information 110, emergency dispatcher 120 may assign emergency event 150 to emergency responders 130 and may communicate emergency event information 110 to emergency responders 130 through the emergency dispatch system. Emergency event information 110 may be transmitted over one or more communication networks to emergency response vehicle 140, and emergency response vehicle 140 may include one or more vehicle-associated computing devices that may present emergency event information 110 to emergency responders 130 while emergency responders 130 are traveling. However, when emergency responders 130 leave emergency response vehicle 140 and operate on scene, access to emergency event information 110 may become limited in some situations, such as when a vehicle-associated computing device is fixed in emergency response vehicle 140, when it is impractical to transport, or when connectivity conditions change. In addition, emergency event information 110 may be updated after emergency responders 130 arrive, such as when additional calls are received, when new hazards are reported, when incident priorities change, or when additional multimedia becomes available, and emergency responders 130 may benefit from being able to view, interpret, and interact with emergency event information 110 while responding to emergency event 150.

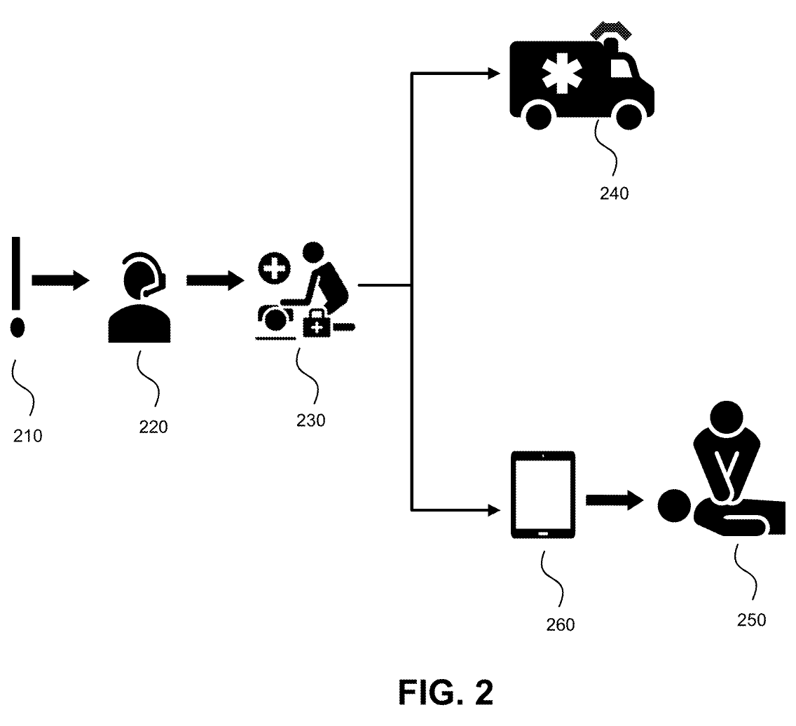

FIG. 2 illustrates an example arrangement for facilitating access to emergency event information 210 when emergency responders 230 are operating away from emergency response vehicle 240. In some embodiments, emergency dispatcher 220 may receive emergency event information 210 and may provide emergency event information 210 to emergency responders 230. Emergency responders 230 may begin responding to an emergency event 250 while traveling in emergency response vehicle 240, and emergency event information 210 may be communicated to emergency responders 230 before arrival and may change after emergency responders 230 arrive and transition to operating at or near emergency event 250. In some embodiments, emergency dispatcher 220, emergency responders 230, emergency response vehicle 240, emergency event 250, and emergency event information 210 may be similar to, or otherwise correspond to, the emergency response entities and information described with respect to FIG. 1.

Emergency responders 230 may include one or more personnel assigned to respond to emergency event 250, and emergency response vehicle 240 may include one or more vehicle-associated computing devices that may present emergency event information 210 while emergency responders 230 are in emergency response vehicle 240. In some embodiments, the availability and usefulness of vehicle-associated computing devices may be impacted when emergency responders 230 exit emergency response vehicle 240, such as when the vehicle is positioned away from emergency event 250, when carrying certain equipment is impractical, or when connectivity conditions at emergency event 250 change. Emergency event information 210 may also change over time, such as when additional callers provide new details, when updated location information is received, when multimedia is received, or when dispatch priorities or assigned resources change. Accordingly, FIG. 2 illustrates an example in which emergency event information 210 may be accessible outside of emergency response vehicle 240 via remote data retrieval tool 260.

Remote data retrieval tool 260 may include any computing device capable of receiving, storing, processing, and presenting emergency event information 210 outside of emergency response vehicle 240. In some embodiments, remote data retrieval tool 260 may be a handheld device, a smartphone, a tablet, a wearable device, a portable radio with a display, or another portable computing device. In some embodiments, remote data retrieval tool 260 may be carried by emergency responders 230, worn by emergency responders 230, mounted to equipment, or otherwise transported for use while responding at or near emergency event 250. Remote data retrieval tool 260 may include a display and user interface elements for presenting emergency event information 210, and remote data retrieval tool 260 may also include input mechanisms that allow emergency responders 230 to interact with emergency event information 210, such as by viewing, acknowledging, annotating, updating, or otherwise working with emergency event information 210 as permitted. In some embodiments, remote data retrieval tool 260 may communicate with one or more systems over one or more wired or wireless networks and may receive emergency event information 210 through one or more communication techniques, such as cellular communications, Wi‑Fi communications, dedicated public safety communications, or other communication channels.

In some embodiments, emergency event information 210 may be transferred to remote data retrieval tool 260 in addition to, or as an alternative to, transfer to a vehicle-associated device within emergency response vehicle 240. For example, emergency event information 210 may be transferred to remote data retrieval tool 260 at dispatch time, while emergency responders 230 are en-route, upon arrival at emergency event 250, on a periodic basis, in response to a user request, or upon detection of an update to emergency event information 210. In some embodiments, emergency event information 210 available via remote data retrieval tool 260 may include location information, incident descriptors, contact information, and multimedia such as photos or video, and remote data retrieval tool 260 may provide emergency responders 230 with access to current emergency event information 210 while operating away from emergency response vehicle 240.

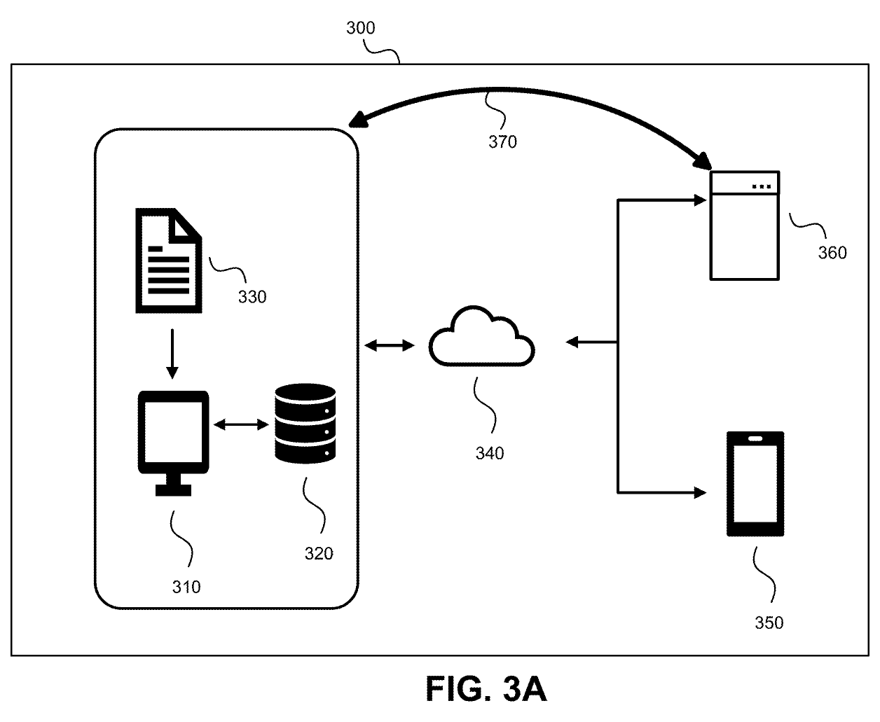

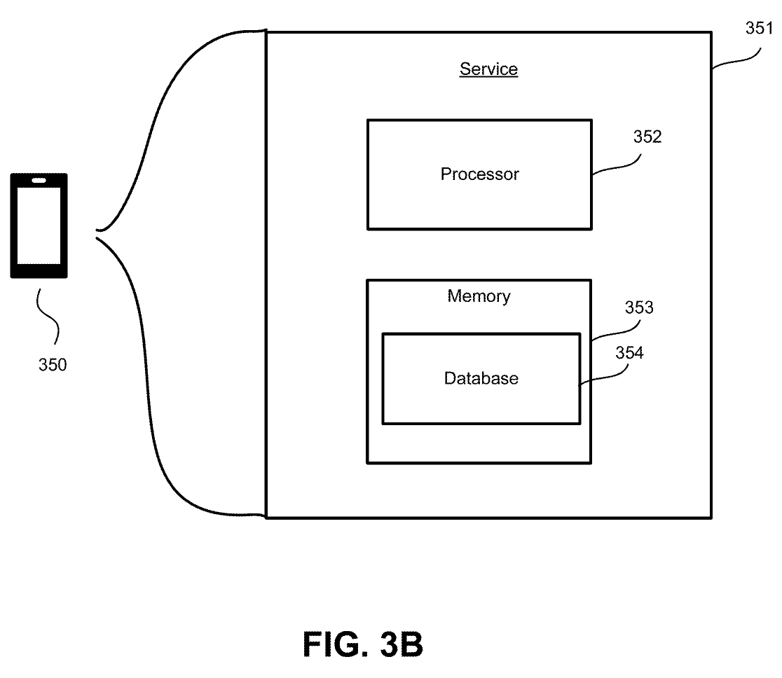

FIG. 3A is a schematic diagram illustrating one embodiment of a system 300 for supporting use of a mobile emergency response application, consistent with disclosed embodiments. In some embodiments, system 300 may include one or more data sources 310, one or more servers 320, data 330, a network 340, a mobile device 350, a mobile device application 360, and one or more communication links 370. In some embodiments, the depicted arrangement is illustrative and not limiting, and one or more components may be combined, subdivided, omitted, duplicated, or implemented in a different order or configuration while remaining consistent with the present disclosure.

In some embodiments, one or more of the data sources 310 may provide information related to emergency events, which may include information that may be collected, updated, or maintained before, during, or after an emergency event. Data sources 310 may include, for example, repositories or systems such as dispatch-related systems (which may include computer aided dispatch (CAD) systems), mapping-related systems (which may include geographic information systems (GIS) and local maps), databases, data warehouses, file stores, sensors, cameras, drones, mobile devices, web services, and application programming interfaces (APIs). In some embodiments, data sources 310 may include one or more relational databases, non-relational databases, distributed databases, cloud-hosted data stores, or other data repositories. In some embodiments, data sources 310 may be updated over time as additional information becomes available, such as when incident details change, additional units are assigned, hazards are reported, or additional multimedia is received.

In some embodiments, server 320 may include any computing device, service, or set of computing resources configured to receive, store, process, and transmit data. For example, server 320 may include one or more application servers, web servers, dispatch-integrated servers, middleware services, gateways, or other computing systems that facilitate access to information from data sources 310 and delivery of information to mobile device 350. In some embodiments, server 320 may perform functions such as brokering requests to data sources 310, aggregating information from multiple data sources 310, applying access controls, formatting or packaging information for transmission, or maintaining one or more data caches. In some embodiments, server 320 may be implemented as on-premises infrastructure, a hosted platform, a cloud service, a virtualized instance, or a combination thereof.

In some embodiments, data 330 may represent information handled or maintained by system 300, which may include information obtained from data sources 310, information generated by server 320, or information provided by mobile device 350 and/or mobile device application 360. Data 330 may include structured, semi-structured, and unstructured data. For example, data 330 may include incident records, unit status information, dispatch notes, timestamps, location data, routing data, maps, images, audio, and video. Data 330 may be stored in one or more formats, and the format may vary depending on the source and use case. For instance, data 330 may include message-style payloads, tabular records, geospatial formats, or multimedia formats. In some embodiments, data 330 may be stored locally, remotely, or in a combination of locations, and data 330 may be updated as new information becomes available.

In some embodiments, network 340 may include one or more communication networks that enable data exchange among components of system 300. Network 340 may include, for example, the Internet, a private data network, a virtual private network, a Wi‑Fi network, a local area network, a wide area network, a cellular network, a public safety broadband network, a dedicated communication network, or combinations thereof. In some embodiments, network 340 may support one or more wired or wireless communication protocols. In some embodiments, network 340 may be secured, partially secured, or unsecured, and communications over network 340 may be encrypted, authenticated, or otherwise protected depending on implementation preferences and deployment constraints.

In some embodiments, mobile device 350 may be any portable computing device capable of communicating over network 340 and executing mobile device application 360. Mobile device 350 may include, for example, a smartphone, a tablet, a wearable device, a ruggedized handheld device, or another portable computing device. In some embodiments, mobile device 350 may include one or more processors, memory, storage, and input/output components such as a display and one or more input mechanisms (e.g., touchscreen, buttons, microphone, camera). In some embodiments, mobile device 350 may be associated with a responder, mounted to responder equipment, or otherwise used in the field while responding to an emergency event.

In some embodiments, mobile device application 360 may include a software application executed by mobile device 350 that enables a user to access, view, and interact with information associated with emergency events. In some embodiments, mobile device application 360 may communicate with server 320 and/or directly with one or more data sources 310 via network 340 to request and receive information. In some embodiments, mobile device application 360 may present emergency event information through a user interface, and the user interface may include interactive elements such as windows, controls, icons, menus, or other interface components. In some embodiments, mobile device application 360 may support user interactions such as selecting an incident, viewing details, filtering what is displayed, and entering updates, notes, or other information. In some embodiments, access to features or information via mobile device application 360 may be controlled through authentication mechanisms, such as password verification, credentials, tokens, or other identity verification techniques.

In some embodiments, mobile device application 360 may process and configure information received through system 300 for use on mobile device 350. For example, information obtained from different data sources 310 may be received in different formats or schemas, and mobile device application 360 and/or server 320 may normalize, map, translate, or otherwise configure the information into a format usable for presentation. In some embodiments, processing and configuring may include assembling a unified incident view from multiple incoming data types, extracting relevant fields, transforming geospatial coordinates into map-ready representations, or preparing multimedia for preview or playback on mobile device 350. In some embodiments, these operations may be performed on mobile device 350, on server 320, or distributed across both.

In some embodiments, communication link 370 may represent one or more data paths or interfaces supporting communications among components of system 300. For example, communication link 370 may represent communications between mobile device application 360 and a collection of backend resources (which may include one or more of server 320 and data 330), and communication link 370 may be implemented through network 340 or through another communication channel. In some embodiments, communication link 370 may support bidirectional communications, such that mobile device application 360 may both receive emergency event information and transmit user inputs, updates, acknowledgements, or other information back to server 320 and/or data 330.

In some embodiments, the components shown in FIG. 3A may operate together to support obtaining emergency event information from one or more data sources 310, transferring emergency event information for use on mobile device 350, processing and configuring the emergency event information for presentation, and displaying the emergency event information through mobile device application 360. In some embodiments, these operations may be performed on demand, periodically, in response to detected updates, or based on user input, and the particular communications paths and functional allocations among components may vary based on deployment and implementation preferences.

FIG. 3B is a block diagram illustrating an example component arrangement associated with mobile device 350, consistent with disclosed embodiments. In some embodiments, mobile device 350 may include service 351. Service 351 may represent one or more software components or logical subsystems associated with mobile device 350 that support receiving, storing, processing, and transmitting data. In some embodiments, service 351 may be implemented as a local service, background process, application component, runtime environment, containerized service, or other execution environment operating on mobile device 350. In other embodiments, service 351 may be implemented at least in part by a remote computing resource that may be logically associated with, addressed by, or otherwise logically linked to mobile device 350, such as an edge computing resource, a hosted service, or a cloud instance, while still being depicted in FIG. 3B as part of the overall mobile-side architecture. In some embodiments, service 351 may support functions such as managing application sessions, coordinating network communications, caching recently accessed emergency event information, packaging data for transmission, logging events, and/or coordinating interactions between the mobile emergency response application and one or more external systems. In some embodiments, service 351 may perform lightweight coordination, caching, and packaging functions, while computationally intensive processing and normalization may be performed by server 320 and/or other remote computing resources.

In some embodiments, service 351 may include one or more processors 352. Processor 352 may include any device or set of devices capable of executing instructions and performing logical operations. For example, processor 352 may include a central processing unit (CPU), a graphics processing unit (GPU), a digital signal processor (DSP), an application-specific integrated circuit (ASIC), a field-programmable gate array (FPGA), a microcontroller, a system-on-a-chip (SoC), or combinations thereof. In some embodiments, processor 352 may execute the mobile emergency response application and/or supporting services associated with service 351, which may include operations for accessing emergency event information, processing and configuring emergency event information, and supporting presentation of emergency event information on mobile device 350. In some embodiments, processor 352 may execute multiple software modules concurrently, such as a data retrieval module, a processing/configuration module, a user interface module, and a storage or cache manager, although the particular software decomposition may vary.

In some embodiments, memory 353 may include one or more storage devices or memory resources configured to store instructions, data, or both for use by processor 352. Memory 353 may include volatile memory, non-volatile memory, or a combination thereof. For example, memory 353 may include random access memory (RAM), read-only memory (ROM), flash memory, a solid-state drive, persistent storage, removable storage, or other tangible storage media. In some embodiments, memory 353 may store instructions that, when executed by processor 352, cause performance of operations associated with the mobile emergency response application and/or service 351. In some embodiments, memory 353 may additionally store data such as cached emergency event information, configuration settings, user interface state, user preferences, authentication artifacts, logging data, and intermediate processing results. In some embodiments, memory 353 may store data in an encrypted form, in segmented partitions, or under access control policies, depending on implementation preferences.

In some embodiments, database 354 may include one or more data repositories coupled to service 351. Database 354 may be implemented as a local on-device database, a file-based store, an object store, an embedded database engine, or another data persistence mechanism. In some embodiments, database 354 may be integrated with service 351 or may be separate from service 351 such that service 351 communicates with database 354 through one or more interfaces or communication links. In some embodiments, database 354 may store emergency event information, which may include incident records, location data, notes, attachments, or metadata. Database 354may additionally or alternatively store application-related data such as user credentials or tokens (where permitted), access control settings, filter definitions, user selections, synchronization state, refresh timestamps, and audit or event logs. In some embodiments, database 354 may store historical records for later review, may store only the most recent incident data as a rolling cache, or may store different categories of data under different retention policies.

In some embodiments, service 351, processor 352, memory 353, and database 354 may operate together to support mobile-side operations of the disclosed techniques. For example, processor 352 may execute instructions stored in memory 353 to obtain emergency event information, process and configure the emergency event information into a format usable for presentation, and provide the processed information for display on mobile device 350. In some embodiments, database 354 may be used to persist emergency event information for offline access, to support caching when connectivity is intermittent, or to enable faster retrieval of previously accessed information. In some embodiments, processor 352 may also store intermediate representations of emergency event information in memory 353 and/or database 354, such as normalized data structures derived from different source formats, so that the mobile emergency response application may present a consistent view of information even when underlying source formats vary. In some embodiments, the particular partitioning of functions among service 351, processor 352, memory 353, and database 354 may vary, and additional components not shown in FIG. 3B (such as input/output interfaces, communication interfaces, sensors, or secure enclaves) may also be included in mobile device 350 depending on implementation preferences.

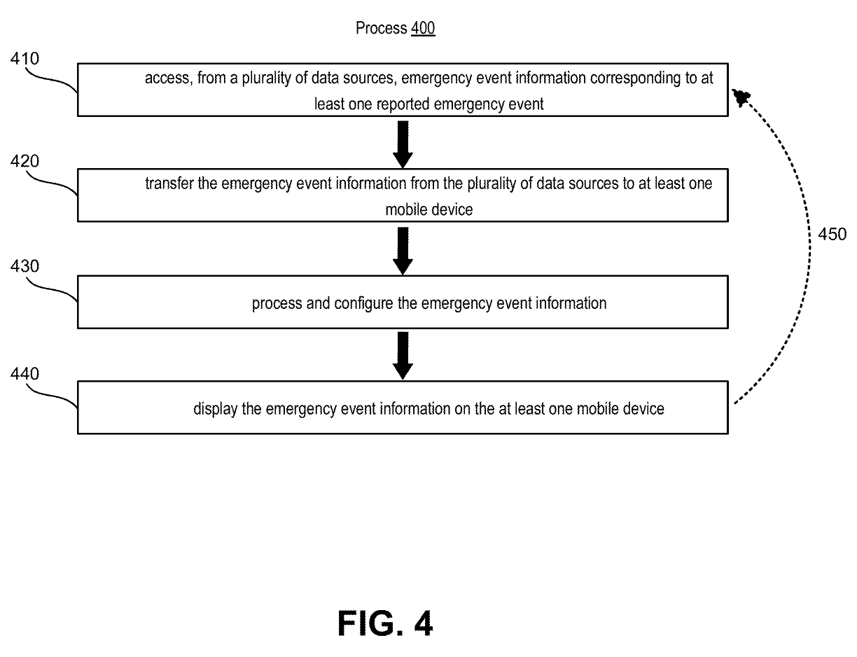

FIG. 4 is a flowchart diagram illustrating one exemplary embodiment of a process 400 for real time emergency event information monitoring using a mobile emergency response application. In some embodiments, process 400 may be implemented using one or more computing devices, which may include at least one mobile device executing the mobile emergency response application. In some embodiments, process 400 may be performed in whole or in part by the mobile device, by one or more remote computing resources, or by a combination thereof, and the allocation of functionality may vary based on implementation preferences.

In some embodiments, process 400 may begin at step 410, in which emergency event information is accessed from a plurality of data sources, and the emergency event information corresponds to at least one reported emergency event. In some embodiments, the plurality of data sources may include one or more dispatch-related systems, mapping-related systems, local mapping resources, databases, sensors, multimedia repositories, or other systems that store, generate, or provide emergency event information. For example, one data source may provide a location and incident classification, another data source may provide mapping or routing information, and another data source may provide multimedia such as photos or video. In some embodiments, emergency event information accessed at step 410 may include one or more of a caller location, a nature of emergency, caller contact information, caller video, caller photos, narrative text, timestamps, responder notes, unit identifiers, or other incident-related context. In some embodiments, accessing at step 410 may occur upon initial dispatch, while responders are en route, upon arrival at a scene, when a user opens a particular incident view, or at another time during response activities.

After step 410, process 400 may proceed to step 420, in which the emergency event information is transferred from the plurality of data sources to at least one mobile device. In some embodiments, the transfer at step 420 may include transmitting emergency event information over one or more wired or wireless networks using one or more protocols suitable for the deployment environment. In some embodiments, the transfer may involve direct transfer from a data source to the mobile device, transfer through an intermediate service that aggregates or brokers communications, or transfer through a sequence of services that package or route emergency event information. In some embodiments, step 420 may include transferring the entirety of available emergency event information, transferring a subset of emergency event information selected based on a user selection or device capability, or transferring incremental updates that reflect changes since a prior transfer.

In some embodiments, the device capability may be determined based on one or more device-reported parameters and/or measured operating conditions of the mobile device, such as available network connectivity and bandwidth, display characteristics, available storage, available processing resources, battery state, and/or supported media formats or codecs. In other embodiments, the mobile emergency response application may obtain at least a portion of the device capability from an operating system interface and/or a device profile, and the system may additionally or alternatively estimate at least a portion of the device capability based on observed performance metrics (e.g., transfer latency, error rates, or throughput) during one or more prior transfers. Further, selecting the subset of information based on device capability may include selecting whether to transfer multimedia, selecting a media resolution or encoding, selecting a level of map detail, selecting a refresh frequency, and/or selecting whether to defer transfer of certain portions of the emergency event information until requested by a user or until a connectivity condition satisfies a threshold. For example, step 420 may transfer an initial incident summary to allow rapid situational awareness and may additionally transfer supplemental information such as multimedia, maps, unit status, or other details as available.

After step 420, process 400 may proceed to step 430, in which the emergency event information is processed and configured. In some embodiments, processing and configuring at step 430 may be performed to prepare emergency event information for use by the mobile emergency response application and for presentation on the mobile device. In some embodiments, emergency event information received from different data sources may arrive in different schemas, formats, or representations, and step 430 may include normalizing the emergency event information from one or more source formats into a normalized format usable by the mobile emergency response application. For example, step 430 may include mapping fields from different data sources into a common incident representation, converting location descriptors into a consistent location format, translating codes or abbreviations into display-ready values, consolidating duplicated data received from multiple sources, or prioritizing among conflicting values when multiple sources provide overlapping information. In some embodiments, step 430 may include preparing multimedia for preview or playback, such as generating thumbnails, selecting a media resolution appropriate for the mobile device, extracting metadata, or associating media items with an incident record.

In some embodiments, step 430 may include generating or updating user interface state, such as identifying which information panels should be populated, which alerts should be shown, or which portions of the emergency event information should be displayed based on user preferences or configuration settings. User preferences or configuration settings may be stored as profile settings associated with a user role, responder unit, jurisdiction, incident type, or combinations thereof, and may control which portions of the emergency event information are displayed and how those portions are organized within the graphical user interface. For example, the profile settings may specify default filters (e.g., by incident type, priority, source, or recency), display density settings (e.g., compact versus expanded views), and a preferred ordering or grouping of information panels (e.g., location and hazards before narrative or media). The profile settings may also specify alerting behavior, such as which alert types are enabled, one or more alert thresholds, escalation rules, and whether alerts are delivered as visual indicators, audible prompts, haptic feedback, or combinations thereof. The profile settings may further specify content-handling policies, such as whether multimedia is auto-downloaded or fetched on demand, whether certain fields are minimized or redacted on a lock screen, and whether selected portions of the emergency event information are cached for offline access subject to storage limits.

In some embodiments, processing and configuring may also include storing incident data and/or normalized data structures in memory and/or a database to support caching and offline access when connectivity is intermittent, which may include maintaining refresh timestamps and applying incremental updates that reflect changes since a prior transfer.

In some embodiments, steps 420 and 430 may be performed in a different order than shown, such that at least a portion of the emergency event information is processed and configured prior to being transferred to the at least one mobile device. For example, a server-side component (e.g., the server 320 described in FIG. 3A) may normalize, map, translate, and/or package emergency event information for transmission, and the at least one mobile device may receive the processed emergency event information for display and/or for further processing based on device capability or user preferences.

After step 430, process 400 may proceed to step 440, in which the emergency event information is displayed on the at least one mobile device. In some embodiments, displaying at step 440 may include presenting emergency event information via a graphical user interface of the mobile emergency response application. In some embodiments, the graphical user interface may present emergency event information using text and icons and may provide one or more user-interactive windows that allow a user to access additional details. In some embodiments, displaying at step 440 may include presenting an emergency event information pane that shows an incident summary and key attributes, such as a location, incident classification, and contact information, and may further include presenting media previews for photos or video where available. In some embodiments, displaying at step 440 may include enabling user editing and data updating, such as allowing a user to enter notes, apply annotations, confirm or correct an incident attribute, update a status value, or otherwise interact with emergency event information as permitted by the deployment. In some embodiments, displaying at step 440 may include receiving a user selection of one or more filters and displaying portions of the emergency event information selected based on the one or more filters, such as filtering by source, incident type, time, priority, unit assignment, media availability, or other criteria. In some embodiments, displaying at step 440 may be performed in a manner that emphasizes rapid comprehension in the field, such as by presenting a compact incident overview alongside expandable details.

In some embodiments, process 400 may include an optional refresh path 450. As illustrated, refresh path 450 may represent repeating one or more portions of process 400 to obtain updated emergency event information. In some embodiments, refresh path 450 may be triggered at one or more times, such as periodically, in response to a user request, in response to detecting that a data source has changed, or in response to a change in application state such as a user switching between incident views. For example, the mobile emergency response application may refresh to obtain newly received multimedia, updated location information, updated responder status, or additional narrative details received after initial dispatch. In some embodiments, refresh path 450 may cause process 400 to return from step 440 to step 410 to re-access emergency event information, and may then proceed through step 420, step 430, and step 440 to transfer, process/configure, and display updated emergency event information. In some embodiments, refresh path 450 may involve repeating only a subset of steps depending on implementation preferences, such as repeating step 410 and step 420 to obtain updates while reusing previously computed configuration state from step 430, or repeating step 440 to update the display based on newly applied filters or user inputs.

In some embodiments, the particular ordering, grouping, or subdivision of steps shown in process 400 is illustrative and not limiting. For example, one or more steps may be combined, expanded into additional sub-steps, performed in parallel, or performed in a different order while remaining consistent with process 400.

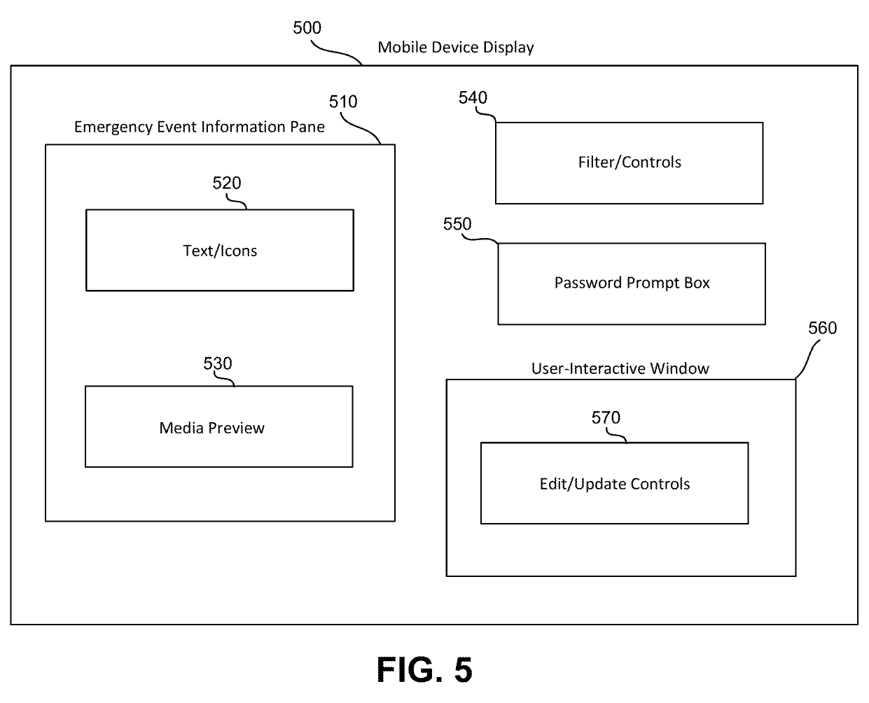

FIG. 5 illustrates one example of a graphical user interface that may be presented on a mobile device display 500 by a mobile emergency response application. In some embodiments, mobile device display 500 may correspond to a display of a mobile device executing the mobile emergency response application. Mobile device display 500 may be implemented using a touchscreen display, an integrated display, an external display, a heads-up style display, a wearable display, or another display type capable of presenting emergency event information and receiving user interaction. The arrangement shown in FIG. 5 is illustrative and not limiting, and the size, position, ordering, and grouping of the depicted interface regions may vary while remaining consistent with the present disclosure.

In some embodiments, mobile device display 500 may include an emergency event information pane 510 configured to present emergency event information in a consolidated view. Emergency event information pane 510 may present an overview of an emergency event (or multiple emergency events) and may be configured to support rapid situational awareness in the field. For example, emergency event information pane 510 may present incident identifiers, timestamps, location descriptors, incident classifications, unit assignments, hazard indicators, staging instructions, and/or other context that may assist a responder in understanding an evolving situation. In some embodiments, emergency event information pane 510 may be updated as emergency event information changes, such as when new details are received, when incident status changes, when additional units are assigned, or when additional media becomes available.

In some embodiments, emergency event information pane 510 may include a text/icons region 520. Text/icons region 520 may present emergency event information using text and graphical icons to enable fast scanning and interpretation. For example, text/icons region 520 may display a location string, a short incident description, one or more status indicators, and icons representing incident type, priority level, unit status, hazards, or other attributes. In some embodiments, text/icons region 520 may include iconography such as badges, symbols, color-coded markers, or other visual cues that convey incident context, response status, or urgency. In some embodiments, text/icons region 520 may also display selectable items (e.g., rows, tiles, cards, or list entries) that a user may tap or otherwise select to open additional details in another region of the interface.

In some embodiments, emergency event information pane 510 may include a media preview region 530. Media preview region 530 may present one or more media items associated with an emergency event, such as photos or video, and may be configured to display thumbnails, preview frames, or a playable media window. In some embodiments, media preview region 530 may present media received from one or more sources, which may include a caller device, a dispatch system, a responder device, a camera feed, or another source that provides multimedia associated with the emergency event. In some embodiments, media preview region 530 may support user interaction, such as selecting a preview to open a larger view, scrubbing within a video, pausing playback, or selecting among multiple media items. In some embodiments, media preview region 530 may present metadata associated with media, such as capture time, source identifier, location tags, or a short caption or summary.

In some embodiments, mobile device display 500 may include filter/controls 540. Filter/controls 540 may provide one or more user-selectable controls that determine which portions of emergency event information are displayed on mobile device display 500, including within emergency event information pane 510. In some embodiments, filter/controls 540 may include one or more drop-down selectors, toggles, checkboxes, buttons, sliders, search fields, tabs, or other user interface controls. For example, filter/controls 540 may allow a user to filter by incident type (e.g., medical, fire, law enforcement), by priority level, by geographic area, by time window, by assigned unit, by data source, by update recency, or by whether media is available. In some embodiments, filter/controls 540 may allow a user to switch between different views of the same emergency event information, such as a summary view, a detail view, a map-centric view, or a media-centric view. In some embodiments, filter/controls 540 may also include controls for refreshing data, acknowledging alerts, bookmarking an incident, or selecting a particular incident when multiple incidents are available.

In some embodiments, mobile device display 500 may include a password prompt box 550. Password prompt box 550 may be presented to support password verification for accessing emergency event information and/or for enabling certain actions within the mobile emergency response application. In some embodiments, password prompt box 550 may be displayed when the mobile emergency response application is launched, when a user attempts to access emergency event information, when a session times out, when a device state changes (e.g., lock/unlock), or when the user attempts to perform a protected action such as editing or updating emergency event information. In some embodiments, password prompt box 550 may include one or more fields for receiving a password or passphrase, and may include additional interface elements such as a submit control, a cancel control, an error indicator, or a “forgot password” flow where available. In some embodiments, password prompt box 550 may be presented as an overlay on mobile device display 500, may be presented as part of a sign-in screen, or may be presented within a secure operating-system-provided authentication dialog.

In some embodiments, mobile device display 500 may include a user-interactive window 560. User-interactive window 560 may provide a space for presenting additional details, enabling user interaction, and supporting workflows associated with emergency event information. In some embodiments, user-interactive window 560 may be implemented as a pop-up window, a side panel, a modal dialog, a bottom sheet, a secondary pane, or another user interface region that can be opened, closed, resized, or repositioned. In some embodiments, user-interactive window 560 may display expanded incident details, communication history, unit status details, hazard notes, directions, or other information that is not shown in the default overview within emergency event information pane 510. In some embodiments, user-interactive window 560 may also present selectable options that allow a user to navigate between different information categories (e.g., “Details,” “Units,” “Notes,” “Media,” “Map”), with the specific categories varying by implementation.

In some embodiments, user-interactive window 560 may include edit/update controls 570. Edit/update controls 570 may enable a user to provide inputs related to emergency event information, such as entering notes, applying annotations, correcting a field, updating a status indicator, acknowledging receipt of information, or otherwise interacting with the information presented by the mobile emergency response application. In some embodiments, edit/update controls 570 may include text entry fields, buttons, selection controls, quick-action controls, or other input mechanisms. For example, edit/update controls 570 may allow a user to add a responder note, update an arrival status, indicate that a hazard is present, attach a photo, flag an item for follow-up, or confirm a location detail. In some embodiments, edit/update controls 570 may be enabled or disabled based on user permissions, authentication state, incident state, or other policy controls, and edit/update controls 570 may be available only after password verification via password prompt box 550. In some embodiments, edits and updates may be stored locally, transmitted to one or more external systems, or both, depending on implementation preferences and connectivity conditions.

In some embodiments, the mobile emergency response application may maintain and present, via the graphical user interface, a synchronization state associated with emergency event information, such as an indication that a portion of the emergency event information is cached locally, pending upload, successfully synchronized, or not synchronized due to intermittent connectivity. In some embodiments, when edits or updates are entered while offline or when competing updates are received from another system, the mobile emergency response application may apply a reconciliation policy (e.g., timestamp-based, source-priority-based, or user-confirmation-based) and may store an audit record identifying the field updated, a prior value, an updated value, a time of the update, and an identifier associated with the source or user that initiated the update. In some embodiments, the synchronization state and/or the audit record may be stored in memory and/or a local database and may be transmitted to one or more external systems when connectivity is available.

In some embodiments, the interface regions shown in FIG. 5 may operate together to support presentation and interaction with emergency event information. For example, filter/controls 540 may be used to select which portions of emergency event information are displayed within emergency event information pane 510, and selections within text/icons region 520 or media preview region 530 may cause user-interactive window 560 to present additional details or enable edit/update controls 570. In some embodiments, mobile device display 500 may present different arrangements depending on device type, display size, orientation, user role, incident type, or connectivity state. The depiction of FIG. 5 is intended to be illustrative and not limiting, and additional interface elements, fewer interface elements, or alternative layouts may be used while remaining consistent with the present disclosure.

The foregoing description is presented for purposes of illustration. It is not exhaustive and is not limited to precise forms or embodiments disclosed. Modifications and adaptations of the embodiments will be apparent from consideration of the specification and practice of the disclosed embodiments. While certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of this disclosure are apparent from this detailed specification, and thus, it is intended that the appended claims cover all systems and methods falling within the scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

What is claimed is:

1. A mobile emergency response system, comprising:
a memory storing instructions;
at least one processor configured to execute the instructions; and
at least one mobile device, configured to execute a mobile emergency response application, wherein execution of the instructions by the at least one processor causes the system to:
remotely access a plurality of data sources;
transfer emergency event information from the plurality of data sources to the at least one mobile device;
process and configure the emergency event information; and
display the emergency event information on the at least one mobile device.

2. The system of claim 1 wherein the at least one processor is further configured to update the emergency event information by refreshing the emergency event information at one or more times, wherein the refreshing is based on at least one of:
user inputs made to the system; or
updates to the plurality of data sources.

3. The system of claim 1, wherein the system is configured to initiate at least one of remotely accessing the plurality of data sources, transferring the emergency event information, processing and configuring the emergency event information, or displaying the emergency event information at least one of:
on demand in response to a user input;
periodically; or
in response to detecting an update to at least one of the plurality of data sources or the emergency event information.

4. The system of claim 1 wherein the plurality of data sources includes one or more of:
a computer aided dispatch (CAD) system;
a geographic information system (GIS); or
local maps.

5. The system of claim 1 wherein emergency event information includes at least one of a caller location, a nature of emergency, caller contact information, caller video, or caller photos.

6. The system of claim 1 wherein the mobile emergency response application is configured to display a graphical user interface (GUI).

7. The system of claim 6, wherein the GUI is configured to:
display the emergency event information using text and icons;
display user-interactive windows for accessing the emergency event information; and
enable user editing and data updating.

8. The system of claim 1, wherein processing and configuring the emergency event information comprises normalizing the emergency event information received from the plurality of data sources from one or more source formats into a normalized format usable by the mobile emergency response application for display.

9. The system of claim 1, wherein accessing the emergency event information via the mobile emergency response application requires password verification.

10. The system of claim 1, wherein the mobile emergency response application is configured to provide a user interface comprising one or more filters selectable by a user to control which portions of the emergency event information from the plurality of data sources are displayed on the at least one mobile device.

11. A method for real time remote emergency event information monitoring, the method comprising:
accessing, from a plurality of data sources, emergency event information corresponding to at least one reported emergency event;
transferring the emergency event information from the plurality of data sources to at least one mobile device;
processing and configuring the emergency event information; and
displaying the emergency event information on the at least one mobile device.

12. The method of claim 11, wherein at least one of accessing, transferring, processing and configuring, or displaying is performed at least one of:
on demand in response to a user input;
periodically; or
in response to detecting an update to at least one of the plurality of data sources or the emergency event information..

13. The method of claim 11, further comprising:
updating the emergency event information by refreshing the emergency event information at one or more times, wherein the refreshing is based on at least one of:
user inputs made via the mobile emergency response application; or
updates to the plurality of data sources.

14. The method of claim 11 wherein the plurality of data sources includes one or more of:
a computer aided dispatch (CAD) system;
a geographic information system (GIS); or
local maps.

15. The method of claim 11 wherein emergency event information includes at least one of a caller location, a nature of emergency, caller contact information, caller video, or caller photos.

16. The method of claim 11, wherein displaying the emergency event information comprises displaying, via a graphical user interface (GUI) of a mobile emergency response application executed by the at least one mobile device, the emergency event information on the at least one mobile device.

17. The method of claim 16, wherein displaying via the GUI comprises:
displaying the emergency event information using text and icons;
displaying user-interactive windows for accessing the emergency event information; and
enabling user editing and data updating.

18. The method of claim 11, wherein processing and configuring the emergency event information comprises normalizing the emergency event information received from the plurality of data sources from one or more source formats into a normalized format usable by the mobile emergency response application for display.

19. The method of claim 11, further comprising requiring password verification to access the emergency event information via the mobile emergency response application.

20. The method of claim 11, wherein displaying the emergency event information comprises:
receiving, via a user interface of the mobile emergency response application, a user selection of one or more filters; and
displaying, on the at least one mobile device, portions of the emergency event information selected based on the one or more filters.

21. A non-transitory computer-readable medium storing instructions that, when executed by at least one processor, cause the at least one processor to:
remotely access a plurality of data sources; transfer emergency event information from the plurality of data sources to at least one mobile device configured to execute a mobile emergency response application; process and configure the emergency event information; and display the emergency event information on the at least one mobile device.

22. The non-transitory computer-readable medium of claim 21, wherein the instructions further cause, during displaying the emergency event information, the mobile emergency response application to:
display at least a portion of the emergency event information using text and icons;
present one or more user-interactive windows for accessing the emergency event information; and
enable user editing and data updating of the emergency event information.
